(19) United States
(12) Patent Application Publication
(10) Pub. No.: US 2012/0070628 A1
(43) Pub. Date: Mar. 22, 2012

(54) Printing dimensionally stable resin inks

(75) Inventors: Wayne A. Wilson, Mesa, AZ (US); David G. Pires, Phoenix, AZ (US)

(73) Assignee: Rogers Corporation, Rogers, CT (US)

(21) Appl. No.: 12/924,010

(22) Filed: Sep. 17, 2010

(51) Int. Cl. B32B 3/10; B41F 33/00

(52) U.S. Cl. 428/195.1; 101/483

(57) ABSTRACT

Small geometry images are printed by coating a surface with a first resin and printing the image from ink containing a second resin on the first resin. The first resin and the second resin are characterized by being solvated by the same solvent. The solvent by which both resins are solvated need not be the solvent used in the inks for either layer. The solvent need not be the same for the inks in both layers. It is believed that solvent from a freshly printed second layer is at least slightly absorbed by the first layer, thereby reducing spreading.

### BACKGROUND OF THE INVENTION

This invention relates to printing resin inks and, in particular, to printing a high resolution image that is dimensionally stable.

### GLOSSARY

As used herein, “dimensionally stable” means that the printed image has substantially the same dimensions after drying or curing as it had when first printed. For screen printing, the printed image has substantially the same dimensions as the image on the screen.

An “image” is any graphic, figure, text, symbol, arbitrary shape, or some combination thereof. An image can be translucent, shaded, colored, a silhouette or outline, or some combination thereof.

An ink includes a resin, a solvent, and, sometimes, a filler. Representative solvents are carbitol acetate (diethylene glycol ethyl ether acetate) and dimethylacetamide (DMAC). The resin can be fluoropolymer, polyester, vinyl, or epoxy The filler can be particles of silver or carbon, for example, to make a conductive ink. Particles of barium titanate can be added to enhance or to modify optical or electrical properties of the image.

“Solvate” and its cognates refer to the attraction and association of molecules of a solvent with molecules of solute. The macro effect of solvating can be swelling, plasticizing, or dissolving, for example. The solvent remains intact. For example, table salt dissolves in water. Ammonia in water is commonly referred to as a solution but ammonia is not solvated by water because the ammonia reacts with water to separate the atoms of the water molecule.

“Small geometry” means an image having a specified dimension, such as a radius, a line segment, or a line width, smaller than one thousand microns. “Specified” in this context means deliberate, not accidental or of no concern.

“High resolution” means that some aspects of an image have a small geometry. As long known in the art, having the solvent and resin for each layer of ink be chemically the same or chemically similar provides chemical compatibility and good adhesion between adjacent layers; e.g., see U.S. Pat. No. 4,816,717 (Harper et al.). It is also known in the art to use a thin layer of solvent as an adhesion promoter. These techniques relate to adhesion, which is quite a different problem from dimensional stability.

The printing art has advanced tremendously in the last couple of decades. Narrowing the field to printing resin-based inks does not change the picture. Nevertheless, a problem remains with screen printing small geometries because the ink tends to spread like pancake batter on a griddle. Increasing the viscosity of the ink is no solution and, even if it were, it would cause other problems.

The problem is particularly acute for printing fine lines of conductors; e.g. lines having a width on the order of fifty microns (approximately two thousandths of an inch) and a comparable spacing. FIG. 1 illustrates a typical result from printing resin ink on a PET (polyethylene terephthalate) substrate. As illustrated in FIG. 1, line 11 has a nominal (screen) width of fifty microns but an actual (printed) width of ninety-four microns.

As another example, also using prior art techniques, one hundred micron lines printed on a PET substrate spread to one hundred thirty microns. Expressed as a percentage, the spread in the second example is a less serious problem but is still a problem. Allowing for such spread is not difficult for straight, parallel lines but is considerably more difficult for images involving corners or curves, particularly closed curves that are not to be filled. Note that the problem decreases with increasing size. A feature with a width of one thousand microns (0.040 inches) may spread twenty to thirty microns but the change is insignificant. The problem addressed by the invention really only exists in producing images having small geometries.

U.S. Pat. No. 6,479,930 (Tanabe et al.) discloses “fine lines” printed on a dielectric layer on PET film but does not disclose the dimensions of the lines or discuss spreading of the lines during printing. In one embodiment, lines are cut rather than printed to obtain “fine lines.”

In view of the foregoing, it is therefore an object of the invention to provide a method for printing dimensionally stable, small geometry images from resin based ink.

Another object of the invention is to provide a method for printing high resolution images from resin based ink.

A further object of the invention is to provide an article having high resolution images printed from resin based ink.

### SUMMARY OF THE INVENTION

The foregoing objects are achieved in this invention by coating a surface with a first resin and printing the image from ink containing a second resin on the first resin.

The first resin and the second resin are characterized by being solvated by the same solvent. The solvent by which both resins can be solvated need not be the solvent used in the ink for either layer. The solvent need not be the same for the inks in both layers.

### BRIEF DESCRIPTION OF THE DRAWINGS

A more complete understanding of the invention can be obtained by considering the following detailed description in conjunction with the accompanying drawings, in which:

FIG. 1 illustrates the problem of ink spreading in the prior art;

FIG. 2 illustrates the result of printing in accordance with the invention;

FIG. 3 is a cross-section of an image printed in accordance with a preferred embodiment of the invention; and

FIG. 4 is a cross-section of an image printed in accordance with alternative embodiments of the invention.

### DETAILED DESCRIPTION OF THE INVENTION

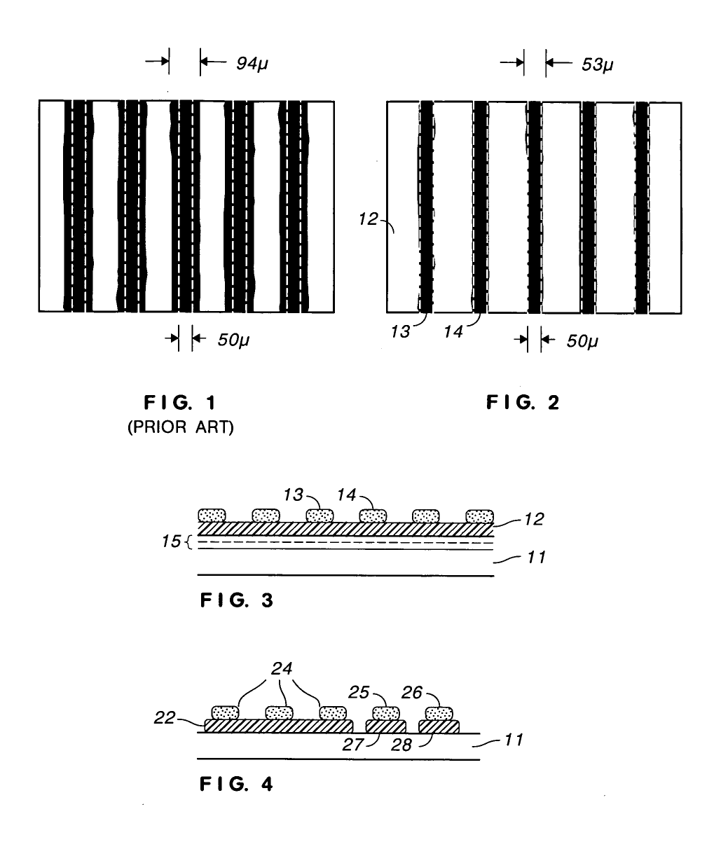

FIG. 1 is a plan view of a PET substrate on which parallel lines having a nominal width of fifty microns were printed using techniques known in the prior art. As indicated in FIG. 1, the printed lines had a width of ninety-four microns.

FIG. 2 is a plan view of a PET substrate on which parallel lines having a nominal width of fifty microns were printed in accordance with the invention. Specifically, “flood” layer 12 (a layer covering the entire area to be printed) of resin is deposited on substrate 11. Then, lines, such as lines 13 and 14, are printed on layer 12 from the same ink as used for the lines in FIG. 1. As indicated in FIG. 2, the printed lines had a width of fifty-three microns, as significant improvement in dimensional stability. Because the image is printed on resin layer 12, rather than directly on substrate 11, the choice of material for substrate 11 is considerably greater than it may have been without the resin layer. Even glass, such as fusion drawn glass, can be used as a substrate.

FIG. 3 is a cross-section of the article illustrated in FIG. 2. Flood layer 12 overlies substrate 11 but may be separated from substrate 11 by one or more optional layers unrelated to this invention, such as an adhesion promoter for layer 12. A flood layer is preferred because it is much easier to apply than a patterned layer and a greater number of techniques can be used to apply the layer if it is not patterned. The choice of technique is a matter of design, depending on cost and the type of resin, for example. Suitable techniques include, spraying, dipping, roll coating, and others presently known or later developed.

FIG. 4 is a cross-section of a substrate printed in accordance with alternative embodiments of the invention, which can be used alone or combined. Resin area 22 is deposited on substrate 11, e.g., by screen printing. The image layer includes areas 24 deposited on resin area 22. In the continuing example of fine conductive traces, several traces are applied to a single area of resin.

Alternatively, each conductive trace can be deposited on a single resin area, as indicated by traces 25 and 26 on areas 27 and 28. Areas 27 and 28, which may spread on substrate 11, do not define traces 25 and 26. The traces are defined by the print screen or other deposition apparatus.

In accordance with another aspect of the invention, it has been found that the resin used for the first layer and the resin used for the second layer can be solvated by the same solvent. The solvent need not be a single compound. The layers need not be based on the same resin. The solvent need not be the same in the inks for each layer. What is necessary is the characteristic that the resins can be solvated by the same solvent, whether or not the solvent is actually used for one or both layers. Solvating is readily determined empirically. It is believed that solvent from a freshly printed second layer is at least slightly absorbed by the first layer, thereby reducing spreading.

### Example 1

### Single Solvent: Carbitol Acetate

A PET substrate was coated with a PVDF/HFP resin and then printed with ink containing polyester resin. PVDF/HFP resin is a polyvinylidene fluoride/hexafluoropropylene resin sold by Arkema Inc. under the trade name Kynar. The polyester resin and the PVDF/HFP resin are solvated with carbitol acetate. Carbitol acetate was the solvent in the ink containing polyester resin. DMAC was the solvent in the ink containing PVDF/HFP resin. This is the combination illustrated in FIG. 2.

### Example 2

### Common Solvent: Carbitol Acetate

A PET substrate was coated with alkyd/melamine resin and then printed with ink containing polyester resin and silver particles. The polyester resin and the alkyd/melamine resin are solvated by carbitol acetate.

The invention thus provides a method for printing dimensionally stable, high resolution images from resin based ink. Articles, such as conductive interconnects on PET substrates are easily and less expensively made in accordance with the invention.

Having thus described the invention, it will be apparent to those of skill in the art that various modifications can be made within the scope of the invention. For example, the solvent can be a mixture of solvents, such as a mixture of ethylene glycol monobutyl ether acetate and diethyleneglycol monoethyl ether acetate for silver bearing ink.

In the following claims, italicized terms are defined and have the meanings given in this specification.

What is claimed as the invention is:

1. A method for printing a high resolution image on a surface, said method comprising the steps of:
coating the surface with a first resin;
printing the image from ink containing a second resin on the first resin;
wherein the first resin and the second resin are characterized by being solvated by the same solvent.

2. The method as set forth in claim 1 wherein the second resin is dissolved in the solvent.

3. The method as set forth in claim 1 wherein the first resin and the second resin are dissolved in the solvent.

4. The method as set forth in claim 1 wherein the first resin is coated on a sheet of PET.

5. The method as set forth in claim 1 wherein the solvent is a mixture of solvents.

6. The method as set forth in claim 1 wherein the first resin is printed in a pattern and the second resin is printed only on the first resin.

7. An article characterized by having a high resolution image on a surface, wherein the high resolution image was printed on a first resin from ink bearing a second resin, wherein the first resin and the second resin are characterized by being solvated by the same solvent.

8. A sheet of PET material characterized by having a high resolution image on a surface, wherein the high resolution image was printed on a first resin from ink bearing a second resin, wherein the first resin and the second resin are characterized by being solvated by the same solvent.
